(19) United States
(12) Patent Application Publication
(10) Pub. No.: US 2025/0189832 A1
(43) Pub. Date: Jun. 12, 2025

(54) OPTICAL ELEMENT, LASER MODULE, RETINAL PROJECTION DEVICE, AND NEAR-EYE WEARABLE DEVICE

(71) Applicant: TDK Corporation, Tokyo (JP)

(72) Inventors: Atsushi SHIMURA, Tokyo (JP); Yasuhiro TAKAGI, Tokyo (JP); Hiroki HARA, Tokyo (JP)

(73) Assignee: TDK Corporation, Tokyo (JP)

(21) Appl. No.: 18/911,503

(22) Filed: Oct. 10, 2024

(30) Foreign Application Priority Data
Dec. 12, 2023 (JP) 2023-209080

(51) Int. Cl. G02F 1/035; G02B 26/10; G02B 27/01

(52) U.S. Cl. CPC G02F 1/0353; G02B 26/105; G02B 27/0172; G02B 2027/0154; G02F 2201/06

(57) ABSTRACT

A mode converter of an optical element includes a taper section having a length in a second direction increases from a first length, at which a first effective refractive index of a TM0 mode is higher than a second effective refractive index of a TE1 mode, to a second length, at which the first effective refractive index is lower than the second effective refractive index. Lengths of a first line section and a second line section in the second direction are set such that a magnitude relationship between the second effective refractive index in the first line section and a third effective refractive index of the TE0 mode in the second line section at a position is inverted to a magnitude relationship between the second effective refractive index in the first line section and the third effective refractive index in the second line section at a second incident end.

### CROSS-REFERENCE TO RELATED APPLICATION

This application claims the benefit of priority from Japanese Patent Application No. 2023-209080 filed with the Japan Patent Office on Dec. 12, 2023, the entire contents of which are incorporated herein by reference.

### TECHNICAL FIELD

The present disclosure relates to an optical element, a laser module, a retinal projection device, and a near-eye wearable device.

### BACKGROUND

The polarization mode of light propagating through the optical waveguide includes a transverse electric (TE) mode, which is a polarization mode having a main electric field in a direction parallel to the substrate, and a transverse magnetic (TM) mode, which is a polarization mode having a main electric field in a direction perpendicular to the substrate. An optical waveguide element for converting these polarization modes is known. For example, Non-Patent Document 1 (Daoxin Dai and John E. Bowers, “Novel concept for ultracompact polarization splitter-rotator based on silicon nanowires”, Optics Express, 2011, Vol. 19, Issue 11, pp. 10940-10949) describes a polarization splitter-rotator including a taper structure and an asymmetrical directional coupler.

### SUMMARY

The optical waveguide element described in Non-Patent Document 1 converts light in TM0 mode having a wavelength of 1.45 μm to 1.6 μm into light in TE0 mode. However, no consideration is given to visible light.

The present disclosure describes an optical element, a laser module, a retinal projection device, and a near-eye wearable device capable of converting a polarization mode of visible light from a TM0 mode to a TE0 mode.

An optical element according to one aspect of the present disclosure includes: a substrate including a main surface; and a core layer provided on the main surface and made of a material having an electro-optic effect. The core layer includes a mode converter that converts a polarization mode of visible light from a TM0 mode to a TE0 mode. The mode converter includes: a first waveguide extending in a first direction along the main surface; and a second waveguide extending in the first direction. The first waveguide includes: a taper section including a first incident end on which the visible light is incident and a first emission end from which the visible light is emitted, the taper section having a length in a second direction along the main surface and intersecting the first direction that increases from a first length at the first incident end to a second length toward the first emission end; and a first line section through which the visible light emitted from the first emission end propagates. The second waveguide includes a second line section arranged side by side with the first line section in the second direction. The first length is a length at which a first effective refractive index, which is an effective refractive index of the TM0 mode, is higher than a second effective refractive index, which is an effective refractive index of a TE1 mode. The second length is a length at which the first effective refractive index is lower than the second effective refractive index. The first line section and the second line section constitute an asymmetrical directional coupler. The asymmetrical directional coupler includes a second incident end and a second emission end which are both ends in the first direction. A length of the first line section in the second direction and a length of the second line section in the second direction are set such that a magnitude relationship between the second effective refractive index in the first line section and a third effective refractive index, which is an effective refractive index of the TE0 mode, in the second line section at a position different from the second incident end of the asymmetrical directional coupler is inverted to a magnitude relationship between the second effective refractive index in the first line section and the third effective refractive index in the second line section at the second incident end.

In the optical element, a region in which the effective refractive index of the TM0 mode and the effective refractive index of the TE1 mode are substantially equal to each other is formed in the taper section. Accordingly, when the visible light in the TM0 mode is incident on the first incident end, an interaction occurs between the TM0 mode and the TE1 mode in the above region. As a result, the polarization mode of the visible light is converted from the TM0 mode to the TE1 mode, and the visible light in the TE1 mode is emitted from the first emission end. Further, a region in which the effective refractive index of the TE1 mode in the first line section and the effective refractive index of the TE0 mode in the second line section are substantially equal to each other is formed between the second incident end of the asymmetrical directional coupler and the position different from the second incident end. Accordingly, when the visible light in the TE1 mode is incident on the second incident end, an interaction occurs between the TE1 mode and the TE0 mode in the above region. As a result, the polarization mode of the visible light is converted from the TE1 mode to the TE0 mode, and the visible light in the TE0 mode is emitted from the second emission end. As described above, the polarization mode of the visible light can be converted from the TM0 mode to the TE0 mode.

The length of the first line section in the second direction may increase from the second incident end toward the above position, and the length of the second line section in the second direction may increase from the second incident end toward the above position. According to this configuration, both the second effective refractive index in the first line section and the third effective refractive index in the second line section increase from the second incident end toward the above position. Therefore, the angle formed by the curve representing the relationship between the position in the first direction and the second effective refractive index in the first line section and the curve representing the relationship between the position in the first direction and the third effective refractive index in the second line section can be reduced as compared with the configuration in which either the second effective refractive index in the first line section or the third effective refractive index in the second line section is constant over the range from the second incident end to the above position. This makes it possible to improve the conversion efficiency from the TE1 mode to the TE0 mode.

The length of the first line section in the second direction may increase from the second incident end toward the above position, and the length of the second line section in the second direction may be constant over a range from the second incident end to the above position. According to this configuration, the second effective refractive index in the first line section increases from the second incident end toward the above position, while the third effective refractive index in the second line section is constant over the range from the second incident end to the above position. Therefore, by increasing the length from the second incident end to the above position, the angle formed by the curve representing the relationship between the position in the first direction and the second effective refractive index in the first line section and the curve representing the relationship between the position in the first direction and the third effective refractive index in the second line section can be reduced. This makes it possible to improve the conversion efficiency from the TE1 mode to the TE0 mode.

The length of the first line section in the second direction and the length of the second line section in the second direction may be set such that a magnitude relationship between the second effective refractive index in the first line section and the third effective refractive index in the second line section at the second emission end is inverted to a magnitude relationship between the second effective refractive index in the first line section and the third effective refractive index in the second line section at the above position. In this case, a region in which the effective refractive index of the TE1 mode in the first line section and the effective refractive index of the TE0 mode in the second line section are substantially equal to each other is formed between the above position and the second emission end, so that an interaction occurs between the TE1 mode and the TE0 mode. Accordingly, the number of conversions from the TE1 mode to the TE0 mode can be increased, and the conversion efficiency can be improved.

The mode converter may further include a flat plate-shaped slab on which the first waveguide and the second waveguide are provided. According to this configuration, the optical coupling between the first waveguide and the second waveguide is made stronger by the visible light seeping out from the first waveguide and the second waveguide to the slab. Accordingly, the conversion efficiency from the TE1 mode to the TE0 mode by the asymmetrical directional coupler can be improved.

A length of the mode converter in a third direction intersecting the first direction and the second direction may be smaller than a wavelength of the visible light. In this case, the visible light is likely to seep out from the first waveguide and the second waveguide to the slab. As a result, the optical coupling between the first waveguide and the second waveguide by the slab can be made stronger. Accordingly, the conversion efficiency from the TE1 mode to the TE0 mode by the asymmetrical directional coupler can be further improved.

A cross-sectional shape of the first waveguide intersecting the first direction may be a trapezoidal shape whose length in the second direction increases toward the main surface. In this case, the first waveguide has an asymmetric shape in the third direction intersecting the first direction and the second direction. Accordingly, the conversion efficiency from the TM0 mode to the TE1 mode by the taper section can be improved.

The core layer may include: a first mode converter which is the mode converter that converts a polarization mode of red light from the TM0 mode to the TE0 mode; a second mode converter which is the mode converter that converts a polarization mode of green light from the TM0 mode to the TE0 mode; a third mode converter which is the mode converter that converts a polarization mode of blue light from the TM0 mode to the TE0 mode; and a multiplexer that multiplexes the red light, the green light, and the blue light to emit laser light. According to this configuration, the polarization mode of the red light is converted from the TM0 mode to the TE0 mode, the polarization mode of the green light is converted from the TM0 mode to the TE0 mode, and the polarization mode of the blue light is converted from the TM0 mode to the TE0 mode. For example, when the multiplexer is designed such that the multiplexing efficiency in the case of multiplexing the red light, the green light, and the blue light in the TE0 mode is higher than the multiplexing efficiency in the case of multiplexing the red light, the green light, and the blue light in the TM0 mode, the multiplexing efficiency in the multiplexer can be improved.

A length of the first mode converter in a third direction intersecting the first direction and the second direction, a length of the second mode converter in the third direction, and a length of the third mode converter in the third direction may be equal to each other. According to this configuration, the first mode converter, the second mode converter, and the third mode converter can be formed on the same substrate, and the length of each mode converter in the third direction can be made the same, so that the manufacture of the optical element can be facilitated.

The core layer may further include: a first modulator that modulates light intensity of the red light; a second modulator that modulates light intensity of the green light; and a third modulator that modulates light intensity of the blue light. In order to output full-color laser light by multiplexing the red light, the green light, and the blue light, it is necessary to adjust the light intensity of light of each color corresponding to the color to be output. According to the above configuration, since the light intensity of the red light, the light intensity of the green light, and the light intensity of the blue light are modulated, it is possible to output full-color laser light without requiring a large drive current.

A laser module according to another aspect of the present disclosure includes: the above-described optical element; a first light source that emits the red light in the TM0 mode; a second light source that emits the green light in the TM0 mode; and a third light source that emits the blue light in the TM0 mode. Since the laser module includes the above-described optical element, the polarization modes of the red light, the green light, and the blue light can be converted from the TM0 mode to the TE0 mode.

A retinal projection device according to still another aspect of the present disclosure is a device mounted on a near-eye wearable device. The retinal projection device includes: the above-described laser module; a movable mirror that performs scanning with the laser light emitted from the laser module; and a reflector that projects an image onto a retina of a user wearing the near-eye wearable device by reflecting the laser light having passed through the movable mirror and irradiating the retina with reflected light. The retinal projection device includes the above-described optical element. Accordingly, in the retinal projection device, it is possible to project an image onto the retina after converting the polarization modes of the red light, the green light, and the blue light from the TM0 mode to the TE0 mode.

A near-eye wearable device according to still another aspect of the present disclosure includes: the above-described retinal projection device; and a lens provided with the reflector. The near-eye wearable device includes the above-described optical element. Accordingly, in the near-eye wearable device, it is possible to project an image onto the retina after converting the polarization modes of the red light, the green light, and the blue light from the TM0 mode to the TE0 mode.

According to each aspect and each embodiment of the present disclosure, the polarization mode of visible light can be converted from the TM0 mode to the TE0 mode.

### BRIEF DESCRIPTION OF THE DRAWINGS

FIG. 1 is a perspective view showing an appearance of a near-eye wearable device to which a laser module according to an embodiment is applied.

FIG. 2 is a configuration diagram schematically showing the retinal projection device shown in FIG. 1.

FIG. 3 is a block diagram of the laser module shown in FIG. 2.

FIG. 4 is a diagram showing a cross-sectional configuration of the optical element shown in FIG. 3.

FIG. 5 is a plan view showing the configuration of the mode converter shown in FIG. 3.

FIG. 6 is a cross-sectional view taken along the line VI-VI of FIG. 5.

FIG. 7 is a diagram for explaining the conversion principle in the mode converter shown in FIG. 5.

FIG. 8 is a block diagram of a laser module according to another embodiment.

FIG. 9 is a block diagram of a laser module according to still another embodiment.

FIG. 10 is a block diagram of a laser module according to still another embodiment.

FIG. 11 is a diagram showing calculation results of conversion loss of red light in the taper section.

FIG. 12 is a diagram showing calculation results of conversion loss of green light in the taper section.

FIG. 13 is a diagram showing calculation results of conversion loss of blue light in the taper section.

FIG. 14 is a diagram showing the relationship between the height of the mode converter, the length of the mode converter in the X-axis direction, and the conversion loss.

FIG. 15 is a diagram showing the relationship between the inclination angle, the length of the mode converter in the X-axis direction, and the conversion loss.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction (second direction) is a direction intersecting (for example, orthogonal to) the X-axis direction (first direction) and the Z-axis direction (third direction). The Z-axis direction is a direction intersecting (for example, orthogonal to) the X-axis direction and the Y-axis direction. In the present specification, the numerical ranges indicated by “to” represent ranges that include the values described before and after “to” as the minimum and maximum values, respectively. The individually described upper and lower limit values can be combined arbitrarily.

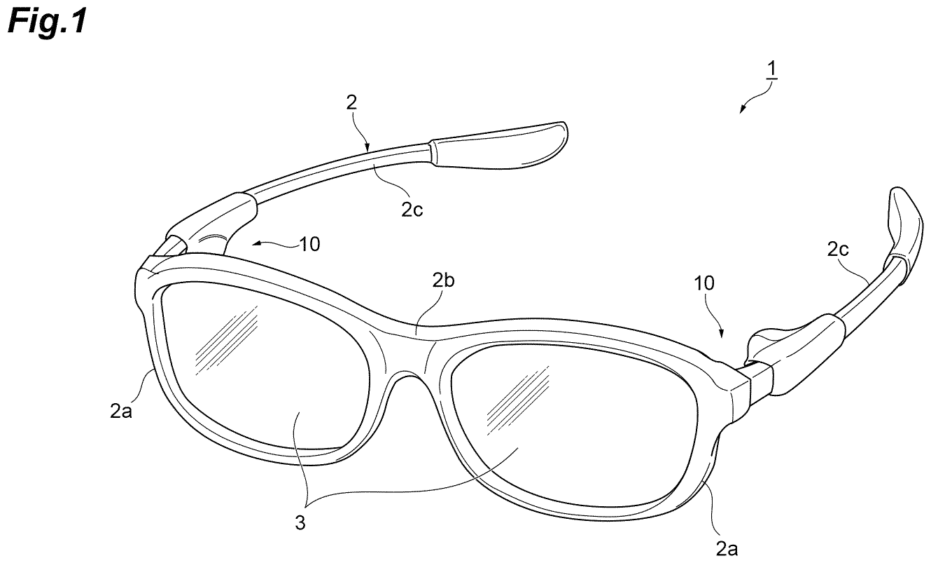

An application example of a laser module according to an embodiment will be described with reference to FIG. 1. FIG. 1 is a perspective view showing an appearance of a near-eye wearable device to which a laser module according to an embodiment is applied. The near-eye wearable device 1 shown in FIG. 1 is a device that projects images onto a retina of a user wearing the near-eye wearable device 1. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, virtual reality (VR) glasses, and mixed reality (MR) glasses. The near-eye wearable device 1 includes a frame 2, a lens 3, and a retinal projection device 10.

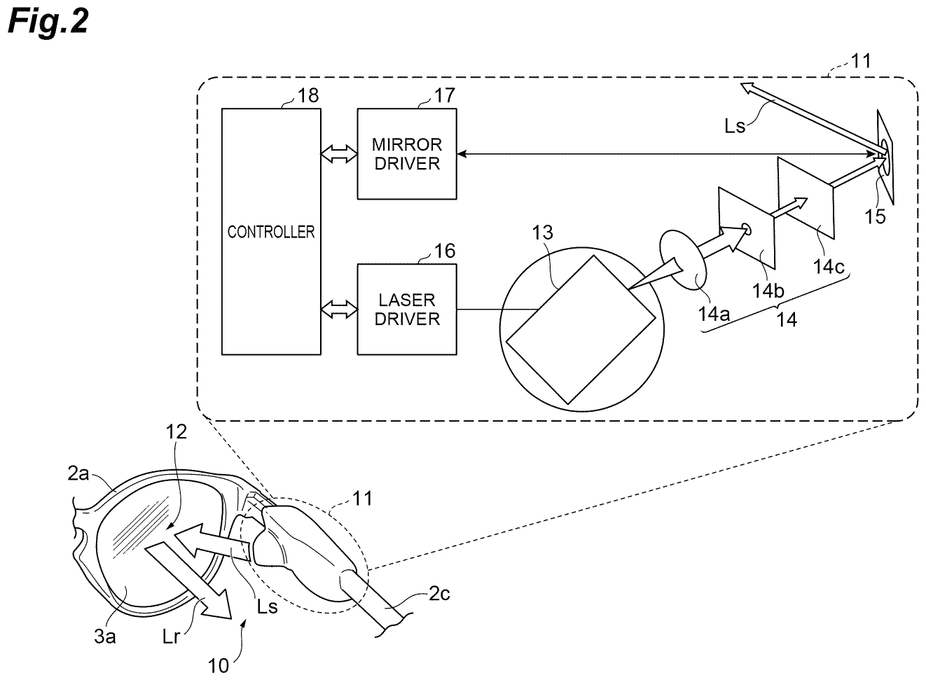

The frame 2 includes a pair of rims 2a, a bridge 2b, and a pair of temples 2c. The rim 2a is a part for holding the lens 3. The bridge 2b is a part connecting the pair of rims 2a. The temple 2c extends from the rim 2a and is a part to be put on an ear of a user. The frame 2 may be a rimless frame. The lens 3 has an inner surface 3a (refer to FIG. 2) facing an eyeball of a user wearing the near-eye wearable device 1.

The retinal projection device 10 is a device for directly projecting (drawing) an image onto a retina of a user wearing the near-eye wearable device 1. The retinal projection device 10 is mounted on the near-eye wearable device 1. In the present embodiment, the near-eye wearable device 1 includes two retinal projection devices 10 in order to project an image onto both the right and left retinas, but may include only one of the retinal projection devices 10.

Next, the retinal projection device 10 will be described in detail with reference to FIG. 2. FIG. 2 is a configuration diagram schematically showing the retinal projection device shown in FIG. 1. As shown in FIG. 2, the retinal projection device 10 includes an optical engine 11 and a reflector 12.

The optical engine 11 is a device that generates laser light Ls having a color and light intensity corresponding to a pixel of an image to be projected onto the retina and emits the laser light Ls to the reflector 12. The optical engine 11 is mounted on the temple 2c. The optical engine 11 includes a laser module 13, optical components 14, a movable mirror 15, a laser driver 16, a mirror driver 17, and a controller 18.

The laser module 13 emits laser light. As the laser module 13, for example, a full-color laser module is used. The laser module 13 emits laser light having a color and light intensity corresponding to a pixel of an image to be projected onto the retina. Details of the laser module 13 will be described later.

The optical components 14 are components that optically process the laser light emitted from the laser module 13. In the present embodiment, the optical components 14 include a collimator lens 14a, a slit 14b, and a neutral density filter 14c. The collimator lens 14a, the slit 14b, and the neutral density filter 14c are arranged in this order along the optical path of the laser light. The optical components 14 may have other configurations.

The movable mirror 15 is a member for performing scanning with the laser light emitted from the laser module 13. The movable mirror 15 is provided in a direction in which the laser light processed by the optical components 14 is emitted. The movable mirror 15 is configured to be swingable about an axis extending in the horizontal direction of the lens 3 and about an axis extending in the vertical direction of the lens 3, for example, and reflects the laser light while changing the angle in the horizontal direction and the vertical direction of the lens 3. As the movable mirror 15, for example, a micro electro mechanical systems (MEMS) mirror is used.

The laser driver 16 is a driving circuit for driving the laser module 13. The laser driver 16 drives the laser module 13 based on, for example, the light intensity of the laser light and the temperature of a light source unit 20 included in the laser module 13. The mirror driver 17 is a driving circuit for driving the movable mirror 15. The mirror driver 17 swings the movable mirror 15 within a predetermined angle range and at a predetermined timing. The controller 18 is a device for controlling the laser driver 16 and the mirror driver 17.

In the optical engine 11, laser light having a color and light intensity corresponding to a pixel of an image to be projected onto the retina is emitted from the laser module 13, passes through the optical components 14, and is reflected by the movable mirror 15. The laser light reflected by the movable mirror 15 is emitted to the reflector 12 as the laser light Ls.

The reflector 12 is a member that projects an image onto the retina of the user wearing the near-eye wearable device 1 by reflecting the laser light Ls having passed through the movable mirror 15 and irradiating the retina with reflected light Lr. The reflector 12 is provided on the inner surface 3a of the lens 3.

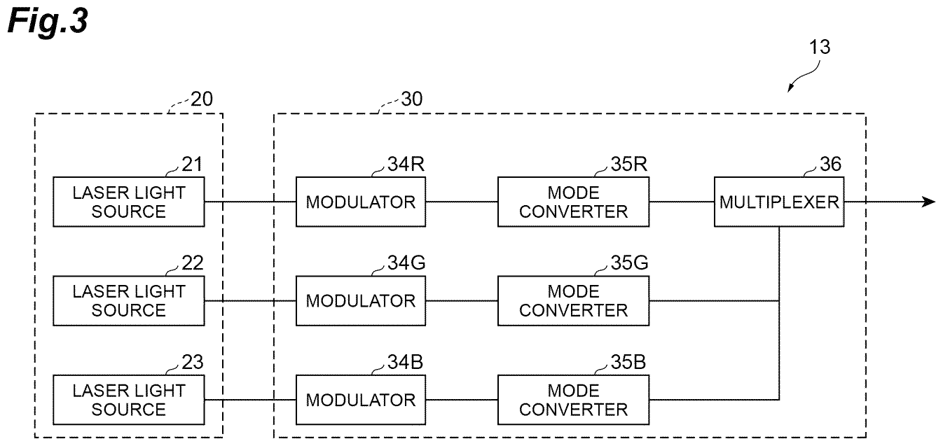

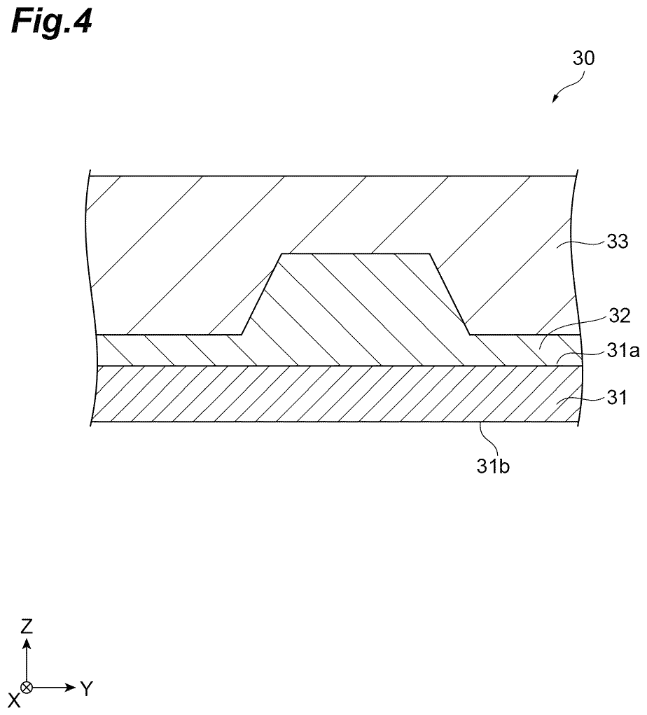

Next, the laser module 13 will be described in detail with reference to FIGS. 3 and 4. FIG. 3 is a block diagram of the laser module shown in FIG. 2. FIG. 4 is a diagram showing a cross-sectional configuration of the optical element shown in FIG. 3. As shown in FIG. 3, the laser module 13 includes the light source unit 20 and an optical element 30.

The light source unit 20 emits visible light. The light source unit 20 includes a laser light source 21 (first light source) for emitting red light, a laser light source 22 (second light source) for emitting green light, and a laser light source 23 (third light source) for emitting blue light. The laser light source 21 is, for example, a red laser diode. The laser light source 22 is, for example, a green laser diode. The laser light source 23 is, for example, a blue laser diode. The peak wavelength of the red light is, for example, in the range of 600 nm to 830 nm. The peak wavelength of the green light is, for example, in the range of 500 nm to 570 nm. The peak wavelength of the blue light is, for example, in the range of 380 nm to 490 nm. The laser light source 21, the laser light source 22, and the laser light source 23 are arranged in that order in the Y-axis direction.

In the present embodiment, the laser light source 21 emits red light in a TM fundamental mode (hereinafter referred to as “TM0 mode”). The laser light source 22 emits green light in the TM0 mode. The laser light source 23 emits blue light in the TM0 mode. Since the red light, the green light, and the blue light are all visible light, in the following description, the red light, the green light, and the blue light may be rephrased as each visible light, and the red light, the green light, and the blue light may be collectively referred to as visible light.

The optical element 30 multiplexes the laser lights emitted from the respective laser light sources into one laser light. The optical element 30 is, for example, a planar lightwave circuit (PLC). As shown in FIG. 4, the optical element 30 includes a substrate 31, a core layer 32, and a cladding layer 33.

The substrate 31 functions as a lower cladding layer. The substrate 31 is made of a material having a refractive index lower than that of the constituent material of the core layer 32. Examples of the constituent materials of the substrate 31 include sapphire, silicon oxide, and silicon laminated with silicon oxide. The substrate 31 includes a main surface 31a and a rear surface 31b opposite to the main surface 31a. The main surface 31a and the rear surface 31b are surfaces defined by the X-axis direction and the Y-axis direction, and intersect with the Z-axis direction (in the present embodiment, the main surface 31a and the rear surface 31b are orthogonal to the Z-axis direction). In other words, the X-axis direction and the Y-axis direction are directions along the main surface 31a.

The cladding layer 33 functions as an upper cladding layer. The cladding layer 33 covers the core layer 32 on the main surface 31a. The cladding layer 33 is provided over the entire surface of the main surface 31a. The cladding layer 33 is made of a material having a refractive index lower than that of the constituent material of the core layer 32. An example of a constituent material of the cladding layer 33 is silicon oxide (e.g., SiO₂).

The core layer 32 is provided on the main surface 31a. The core layer 32 is made of a material having an electro-optic effect. The electro-optic effect is a phenomenon in which the refractive index of a material is changed by applying an electric field to the material. An example of a constituent material of the core layer 32 is lithium niobate (LiNbO₃). In the present embodiment, the core layer 32 is a lithium niobate thin film formed on the main surface 31a of the substrate 31 by sputtering, and the optical axis (C-axis) of the lithium niobate extends in the Z-axis direction. The core layer 32 may be composed of Z-cut lithium niobate.

The core layer 32 includes a modulator 34R (first modulator), a modulator 34G (second modulator), a modulator 34B (third modulator), a mode converter 35R (first mode converter), a mode converter 35G (second mode converter), a mode converter 35B (third mode converter), and a multiplexer 36.

The modulator 34R is a modulator that modulates the light intensity of the red light. The modulator 34R modulates the light intensity of the red light in the TM0 mode emitted from the laser light source 21. The modulator 34G is a modulator that modulates the light intensity of the green light. The modulator 34G modulates the light intensity of the green light in the TM0 mode emitted from the laser light source 22. The modulator 34B is a modulator that modulates the light intensity of the blue light. The modulator 34B modulates the light intensity of the blue light in TM0 mode emitted from the laser light source 23. Each modulator is, for example, a Mach-Zehnder modulator.

The mode converter 35R is a mode converter for converting the polarization mode of the red light from the TM0 mode to the TE fundamental mode (hereinafter referred to as “TE0 mode”). The mode converter 35R is provided subsequent to the modulator 34R and converts the polarization mode of the red light emitted from the modulator 34R from the TM0 mode to the TE0 mode. The mode converter 35G is a mode converter for converting the polarization mode of the green light from the TM0 mode to the TE0 mode. The mode converter 35G is provided subsequent to the modulator 34G and converts the polarization mode of the green light emitted from the modulator 34G from the TM0 mode to the TE0 mode. The mode converter 35B is a mode converter for converting the polarization mode of the blue light from the TM0 mode to the TE0 mode. The mode converter 35B is provided subsequent to the modulator 34B and converts the polarization mode of the blue light emitted from the modulator 34B from the TM0 mode to the TE0 mode.

The polarization mode is also referred to as a waveguide mode. The TM mode is a polarization mode in which the main component of the electric field in the cross section perpendicular to the light propagation direction is oriented perpendicular to the main surface 31a of the substrate 31. The TE mode is a polarization mode in which the main component of the electric field in the cross section perpendicular to the light propagation direction is oriented parallel to the main surface 31a of the substrate 31. The TM0 mode is a polarization mode having the highest effective refractive index among the TM modes. The TE0 mode is a polarization mode having the highest effective refractive index among the TE modes. The TE first-order mode (hereinafter referred to as “TE1 mode”) is a polarization mode having the second highest effective refractive index among the TE modes.

Each of the mode converter 35R, the mode converter 35G, and the mode converter 35B extends in the X-axis direction. The mode converter 35R, the mode converter 35G, and the mode converter 35B are arranged in that order in the Y-axis direction. The detailed configuration of each mode converter will be described later.

The multiplexer 36 multiplexes the red light, the green light, and the blue light. The multiplexer 36 multiplexes the red light emitted from the mode converter 35R, the green light emitted from the mode converter 35G, and the blue light emitted from the mode converter 35B into a single laser light to emit the laser light. The laser light contains a component having a red wavelength (red component), a component having a green wavelength (green component), and a component having a blue wavelength (blue component).

In the laser module 13, visible light in the TM0 mode is emitted from each laser light source, the light intensity of each visible light is modulated by each modulator, and then the polarization mode of the visible light is converted from the TM0 mode to the TE0 mode by each mode converter. Then, each visible light whose polarization mode has been converted is multiplexed by the multiplexer 36 to be emitted from the multiplexer 36 to the optical components 14 (refer to FIG. 2) as laser light in the TE0 mode.

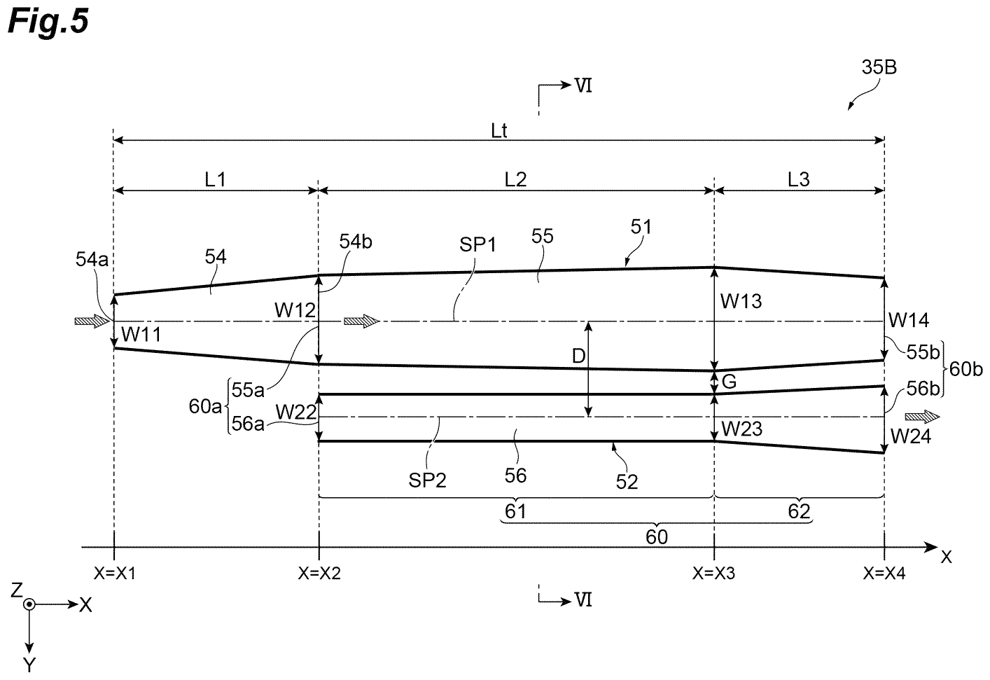

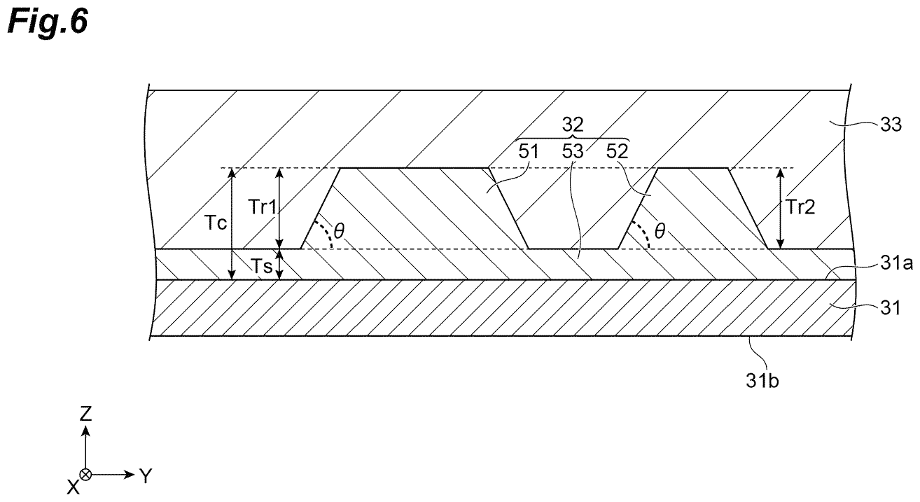

Next, the detailed configurations of the mode converter 35R, the mode converter 35G, and the mode converter 35B will be described with reference to FIGS. 5 and 6. FIG. 5 is a plan view showing the configuration of the mode converter shown in FIG. 3. FIG. 6 is a cross-sectional view taken along the line VI-VI of FIG. 5. Here, the mode converter 35B will be exemplified. As shown in FIGS. 5 and 6, the mode converter 35B forms a ridge waveguide, and includes a waveguide 51 (first waveguide), a waveguide 52 (second waveguide), and a slab 53. In FIG. 5, only the waveguide 51 and the waveguide 52 are shown for convenience of explanation.

The slab 53 is a flat plate-shaped portion of the ridge waveguide. The slab 53 is provided on the main surface 31a. The waveguide 51 and the waveguide 52 are provided on the slab 53. The waveguide 51, the waveguide 52, and the slab 53 are made of the same material. The length (height Ts) of the slab 53 in the Z-axis direction is, for example, 0 μm to 0.2 μm. Hereinafter, the length in the Z-axis direction may be referred to as “height”. Note that the height Ts of 0 μm means that the slab 53 is not provided. In other words, the mode converter 35B is not required to include the slab 53.

The waveguide 51 is a protruding portion of the ridge waveguide. The waveguide 51 is provided on the slab 53 and extends linearly in the X-axis direction. The waveguide 51 may have a shape that is symmetric with respect to the symmetry plane SP1. The symmetry plane SP1 is a virtual plane defined by the X-axis direction and the Z-axis direction, and passes through the center of the waveguide 51 in the Y-axis direction.

The cross-sectional shape of the waveguide 51 intersecting (orthogonal to) the X-axis direction is a trapezoidal shape whose length in the Y-axis direction increases toward the main surface 31a. In the present embodiment, the above-described cross-sectional shape of the waveguide 51 is an isosceles trapezoid. The inclination angle θ is, for example, 86° or less. The inclination angle θ is an angle between the bottom surface and the side surface of the waveguide 51. The above-described cross-sectional shape of the waveguide 51 may be rectangular. Hereinafter, the length in the Y-axis direction may be referred to as “width”. The height Tr1 of the waveguide 51 is substantially constant over the entire length of the waveguide 51 in the X-axis direction. The height Tr1 is, for example, 0.2 μm to 1.0 μm.

The waveguide 52 is a protruding portion of the ridge waveguide. The waveguide 52 is provided on the slab 53 and extends linearly in the X-axis direction. The waveguide 52 is provided side by side with a part of the waveguide 51 in the Y-axis direction. The waveguide 52 may have a shape that is symmetric with respect to the symmetry plane SP2. The symmetry plane SP2 is a virtual plane defined by the X-axis direction and the Z-axis direction, and passes through the center of the waveguide 52 in the Y-axis direction.

The cross-sectional shape of the waveguide 52 intersecting (orthogonal to) the X-axis direction is a trapezoidal shape whose width increases toward the main surface 31a. In the present embodiment, the above-described cross-sectional shape of the waveguide 52 is an isosceles trapezoid. The angle between the bottom surface and the side surface of the waveguide 52 is substantially the same as the inclination angle θ. The above-described cross-sectional shape of the waveguide 52 may be rectangular. The height Tr2 of the waveguide 52 is substantially constant over the entire length of the waveguide 52 in the X-axis direction, and is substantially the same as the height Tr1 of the waveguide 51.

The length Lt of the mode converter 35B in the X-axis direction is the sum of a length L1, a length L2, and a length L3 described later. The length Lt is, for example, 15 μm to 150,000 μm. The height Tc of the mode converter 35B is substantially constant over the entire length of the mode converter 35B in the X-axis direction. The height Tc is the sum of the height Tr1 (or the height Tr2) and the height Ts. The height Tc is, for example, smaller than the wavelength of visible light (blue light in this case) to be converted. The height Tc is, for example, 0.2 μm to 1.2 μm.

The waveguide 51 includes a taper section 54 and a line section 55 (first line section). The waveguide 52 includes a line section 56 (second line section).

The taper section 54 functions as a converter for converting the polarization mode of visible light (blue light in this case) from the TM0 mode to the TE1 mode. The taper section 54 includes an incident end 54a (first incident end) and an emission end 54b (first emission end) which are both ends in the X-axis direction. The incident end 54a is positioned at a position X1 in the X-axis direction. The emission end 54b is positioned at a position X2 in the X-axis direction. The blue light is incident on the incident end 54a from the modulator 34B. The emission end 54b emits the blue light to the line section 55. The length L1 of the taper section 54 in the X-axis direction is, for example, 5 μm to 50,000 μm.

The width of the taper section 54 increases from the incident end 54a toward the emission end 54b. Specifically, the width of the taper section 54 continuously increases from the width W11 (first length) at the incident end 54a to the width W12 (second length) toward the emission end 54b. The rate of increase in the width of the taper section 54 may be substantially constant. The width W11 of the taper section 54 at the incident end 54a is set to such a width that the effective refractive index (first effective refractive index) of the TM0 mode is higher than the effective refractive index (second effective refractive index) of the TE1 mode and lower than the effective refractive index of the TE0 mode. The width W11 is, for example, 0.3 μm to 1.0 μm. The width W12 of the taper section 54 at the emission end 54b is set to such a width that the effective refractive index of the TM0 mode is lower than the effective refractive index of the TE1 mode. The width W12 is larger than the width W11 and is, for example, 0.4 μm to 1.2 μm.

The line section 55 is provided subsequent to the taper section 54, and is a section through which the blue light emitted from the emission end 54b propagates. The line section 55 includes one end 55a and the other end 55b which are both ends in the X-axis direction. The one end 55a is connected to the emission end 54b. The blue light emitted from the taper section 54 is incident on the one end 55a. The blue light can be emitted from the other end 55b.

The line section 56 is arranged side by side with the line section 55 in the Y-axis direction. The line section 56 includes one end 56a and the other end 56b which are both ends in the X-axis direction. The blue light can be emitted from the other end 56b.

The line section 55 and the line section 56 are arranged side by side in the Y-axis direction, and constitute an asymmetrical directional coupler 60. The center of the line section 55 in the Y-axis direction is separated from the center of the line section 56 in the Y-axis direction by a distance D. The distance D is, for example, 0.4 μm to 2.0 μm. The line section 55 and the line section 56 are spaced apart from each other in the Y-axis direction. The minimum gap G between the line section 55 and the line section 56 is, for example, 0.1 μm to 0.9 μm.

The asymmetrical directional coupler 60 includes an incident end 60a (second incident end) and an emission end 60b (second emission end) which are both ends in the X-axis direction. The incident end 60a is constituted by the one end 55a and the one end 56a. The emission end 60b is constituted by the other end 55b and the other end 56b. The incident end 60a is positioned at the position X2 in the X-axis direction. The emission end 60b is positioned at a position X4 in the X-axis direction.

The asymmetrical directional coupler 60 is divided into a conversion region 61 and a conversion region 62 at a position X3 in the X-axis direction. The position X3 is a position between the incident end 60a (position X2) and the emission end 60b (position X4) in the X-axis direction. The conversion region 61 is a region from the incident end 60a to the position X3 in the asymmetrical directional coupler 60. The conversion region 62 is a region from the position X3 to the emission end 60b in the asymmetrical directional coupler 60. The length L2 of the conversion region 61 in the X-axis direction is, for example, 5 μm to 50,000 μm. The length L3 of the conversion region 62 in the X-axis direction is, for example, 5 μm to 50,000 μm.

In the conversion region 61, the width of the line section 55 and the width of the line section 56 are set such that the magnitude relationship between the effective refractive index of the TE1 mode in the line section 55 and the effective refractive index of the TE0 mode in the line section 56 at the position X3 is inverted with respect to the magnitude relationship between the effective refractive index of the TE1 mode in the line section 55 and the effective refractive index of the TE0 mode in the line section 56 at the incident end 60a. In the present embodiment, in the conversion region 61, the widths of the line section 55 and the line section 56 are set such that the effective refractive index of the TE1 mode in the line section 55 is lower than the effective refractive index (third effective refractive index) of the TE0 mode in the line section 56 at the incident end 60a, and the effective refractive index of the TE1 mode in the line section 55 is higher than the effective refractive index of the TE0 mode in the line section 56 at the position X3.

In the present embodiment, in the conversion region 61, the width of the line section 55 increases from the incident end 60a (one end 55a) toward the position X3. More specifically, in the conversion region 61, the width of the line section 55 continuously increases from the width W12 to the width W13. The rate of increase in the width of the line section 55 in the conversion region 61 may be substantially constant. The width W13 is larger than the width W12 and is, for example, 0.4 μm to 1.5 μm.

In the conversion region 61, the width of the line section 56 is substantially constant over a range from the incident end 60a (one end 56a) to the position X3. In other words, the width W22 at the one end 56a of the line section 56 is substantially the same as the width W23 at the position X3 of the line section 56. The width of the line section 56 may increase from the incident end 60a (one end 56a) toward the position X3. The width W22 is, for example, 0.2 μm to 1.0 μm. The width W23 is, for example, 0.2 μm to 1.0 μm.

In the conversion region 62, the width of the line section 55 and the width of the line section 56 are set such that the magnitude relationship between the effective refractive index of the TE1 mode in the line section 55 and the effective refractive index of the TE0 mode in the line section 56 at the emission end 60b is inverted with respect to the magnitude relationship between the effective refractive index of the TE1 mode in the line section 55 and the effective refractive index of the TE0 mode in the line section 56 at the position X3. In the present embodiment, in the conversion region 62, the width of the line section 55 and the width of the line section 56 are set such that, at the position X3, the effective refractive index of the TE1 mode in the line section 55 is higher than the effective refractive index of the TE0 mode in the line section 56, and at the emission end 60b, the effective refractive index of the TE1 mode in the line section 55 is lower than the effective refractive index of the TE0 mode in the line section 56.

In the present embodiment, in the conversion region 62, the width of the line section 55 decreases from the position X3 toward the emission end 60b (the other end 55b). More specifically, in the conversion region 62, the width of the line section 55 continuously decreases from the width W13 to the width W14. The rate of decrease in the width of the line section 55 may be substantially constant. The width W14 is smaller than the width W13 and is, for example, 0.4 μm to 1.2 μm.

In the conversion region 62, the width of the line section 56 increases from the position X3 toward the emission end 60b (the other end 56b). More specifically, in the conversion region 62, the width of the line section 56 continuously increases from the width W23 to the width W24. The rate of increase in the width of the line section 56 in the conversion region 62 may be substantially constant. The width W24 is larger than the width W23 and is, for example, 0.2 μm to 1.0 μm.

The mode converters 35R and 35G have the same configuration as that of the mode converter 35B. The mode converters 35R and 35G are not required to include the conversion region 62. The height of the mode converter 35R and the height of the mode converter 35G are substantially the same as the height Tc of the mode converter 35B.

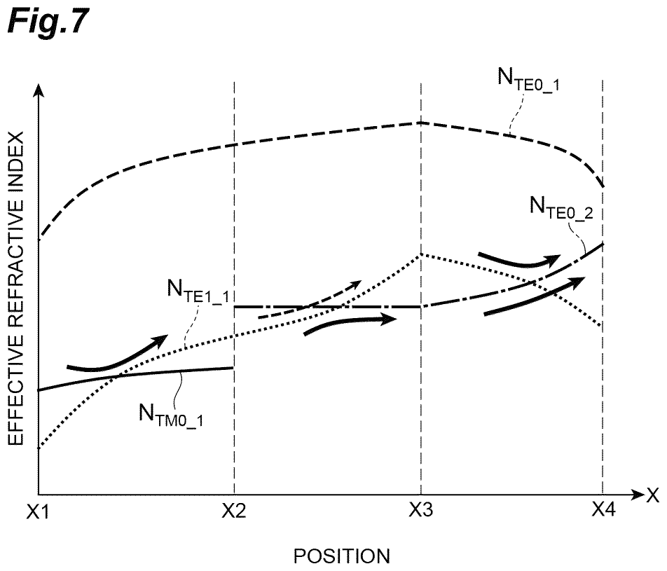

Next, the conversion principle in the mode converter 35R, the mode converter 35G, and the mode converter 35B will be described with further reference to FIG. 7. FIG. 7 is a diagram for explaining the conversion principle in the mode converter shown in FIG. 5. The horizontal axis in FIG. 7 indicates the position in the X-axis direction, and the vertical axis in FIG. 7 indicates the effective refractive index.

The effective refractive index in a waveguide depends on the constituent material of the waveguide, the polarization mode of light propagating through the waveguide, the cross-sectional shape of the waveguide, and the cross-sectional area of the waveguide. For example, when the cross-sectional area of the waveguide is large, the light is strongly confined in the waveguide and is easily affected by the refractive index of the constituent material of the waveguide, so that the effective refractive index becomes high. On the other hand, when the cross-sectional area of the waveguide is small, the confinement of the light is weakened and the light leaks out to the substrate 31 and the cladding layer 33, so that the effective refractive index becomes low.

The term “effective refractive index” means the effective refractive index in an isolated waveguide. For example, the effective refractive index N_{TE1_1} of the TE1 mode in the waveguide 51 means the effective refractive index of the TE1 mode in the case where only the waveguide 51 is present. That is, the effective refractive index N_{TE1_1} means the effective refractive index of the TE1 mode assuming that the waveguide 52 is not present. The state in which the waveguide 52 is not present refers to a state in which a portion where the waveguide 52 is present is replaced with the same material as the cladding layer 33.

Similarly, the effective refractive index N_{TM0_1} of the TM0 mode in the waveguide 51 means the effective refractive index of the TM0 mode in the case where only the waveguide 51 is present. The effective refractive index N_{TE0_1} of the TE0 mode in the waveguide 51 means the effective refractive index of the TE0 mode in the case where only the waveguide 51 is present. The effective refractive index N_{TE0_2} of the TE0 mode in the waveguide 52 means the effective refractive index of the TE0 mode in the case where only the waveguide 52 is present.

First, the conversion principle in the taper section 54 will be described. As shown in FIG. 7, in the taper section 54, the effective refractive index N_{TM0_1}, the effective refractive index N_{TE0_1}, and the effective refractive index N_{TE1_1} all increase from the position X1 toward the position X2. As described above, the width W11 at the incident end 54a (position X1) of the taper section 54 is set to such a width that the effective refractive index N_{TM0_1} is higher than the effective refractive index N_{TE1_1} and lower than the effective refractive index N_{TE0_1}. The width W12 at the emission end 54b (position X2) of the taper section 54 is set to such a width that the effective refractive index N_{TM0_1} is lower than the effective refractive index N_{TE1_1}.

The magnitude relationship between the effective refractive index N_{TM0_1} and the effective refractive index N_{TE1_1} is inverted between the position X1 and the position X2, and an interaction occurs between the TM0 mode and the TE1 mode in a region where the effective refractive index N_{TM0_1} and the effective refractive index N_{TE1_1} are substantially equal. The position at which the magnitude relationship between the effective refractive index N_{TM0_1} and the effective refractive index N_{TE1_1} is inverted may be an intermediate point between the position X1 and the position X2.

When the visible light in the TM0 mode is incident on the incident end 54a of the taper section 54, the visible light propagates through the taper section 54. In the region where the effective refractive index N_{TM0_1} and the effective refractive index N_{TE1_1} are substantially equal to each other, an interaction occurs between the TM0 mode and the TE1 mode, and the polarization mode of the visible light is converted from the TM0 mode to the TE1 mode. Then, the visible light in the TE1 mode is emitted from the emission end 54b. The length L1 is set such that the conversion efficiency from the TM0 mode to the TE1 mode is maximized.

Between the position X1 and the position X2, the effective refractive index N_{TE0_1} is separated from the effective refractive indices of other polarization modes. Accordingly, when the visible light in the TE0 mode is incident on the incident end 54a, the visible light propagates through the taper section 54 while maintaining the polarization mode in the TE0 mode, and the visible light in the TE0 mode is emitted from the emission end 54b.

Subsequently, the conversion principle in the asymmetrical directional coupler 60 will be described. As described above, the width of the line section 55 and the width of the line section 56 are set such that the effective refractive index N_{TE1_1} is lower than the effective refractive index N_{TE0_2} at the position X2, the effective refractive index N_{TE1_1} is higher than the effective refractive index N_{TE0_2} at the position X3, and the effective refractive index N_{TE1_1} is lower than the effective refractive index N_{TE0_2} at the position X4.

In general, when the effective refractive indices of two polarization modes propagating through two parallel waveguides are close to each other, the interaction between the two polarization modes becomes stronger, making it easier for conversion from one polarization mode to the other polarization mode to occur. The reason for this is that the closer the phase velocities (speed of light divided by effective refractive index) of the two polarization modes are to each other, the more the conditions for propagation in adjacent waveguides are satisfied.

The magnitude relationship between the effective refractive index N_{TE1_1} and the effective refractive index N_{TE0_2} is inverted between the position X2 and the position X3, and an interaction occurs between the TE1 mode in the line section 55 and the TE0 mode in the line section 56 in a region where the effective refractive index N_{TE1_1} and the effective refractive index N_{TE0_2} are substantially equal to each other. The position where the magnitude relationship between the effective refractive index N_{TE1_1} and the effective refractive index N_{TE0_2} is inverted may be an intermediate point between the position X2 and the position X3.

Furthermore, the magnitude relationship between the effective refractive index N_{TE1_1} and the effective refractive index N_{TE0_2} is again inverted between the position X3 and the position X4, and an interaction occurs between the TE1 mode in the line section 55 and the TE0 mode in the line section 56 in a region where the effective refractive index N_{TE1_1} and the effective refractive index N_{TE0_2} are substantially equal to each other. The position where the magnitude relationship between the effective refractive index N_{TE1_1} and the effective refractive index N_{TE0_2} is inverted may be an intermediate point between the position X3 and the position X4.

When the visible light in the TE1 mode is incident on the one end 55a of the line section 55, the visible light propagates through the line section 55. At this time, in the region between the position X2 and the position X3 where the effective refractive index N_{TE1_1} and the effective refractive index N_{TE0_2} are substantially equal to each other, an interaction occurs between the TE1 mode in the line section 55 and the TE0 mode in the line section 56. As a result, the polarization mode of the visible light is converted from the TE1 mode to the TE0 mode, and the visible light in TE0 mode propagates through the line section 56. Of the visible light propagating through the line section 55, the remaining portion not converted into the TE0 mode propagates through the line section 55 while maintaining the polarization mode of the visible light in the TE1 mode.

Then, in the region between the position X3 and the position X4 where the effective refractive index N_{TE1_1} and the effective refractive index N_{TE0_2} are substantially equal to each other, an interaction occurs between the remaining TE1 mode propagating through the line section 55 and the TE0 mode in the line section 56. As a result, the polarization mode of the visible light is converted from the TE1 mode to the TE0 mode, and the visible light in TE0 mode propagates through the line section 56. Then, the visible light in the TE0 mode is emitted from the other end 56b. The lengths L2 and L3 are set so as to maximize the conversion efficiency from the TE1 mode to the TE0 mode. Accordingly, the conversion from the TE1 mode to the TE0 mode hardly occurs between the position X3 and the position X4.

Between the position X2 and the position X4, the effective refractive index N_{TE0_1} is separated from the effective refractive indices of other polarization modes. Accordingly, when the visible light in the TE0 mode is incident on the one end 55a, the visible light propagates through the line section 55 while maintaining the polarization mode in the TE0 mode, and the visible light in the TE0 mode is emitted from the other end 55b.

As described above, since the effective refractive index N_{TE1_1} and the effective refractive index N_{TE0_2} are substantially equal to each other in the plurality of regions, the number of conversions from the TE1 mode to the TE0 mode can be increased, and the conversion efficiency can be improved.

In the laser module 13 and the optical element 30 described above, the region in which the effective refractive index N_{TM0_1} and the effective refractive index N_{TE1_1} are substantially equal to each other is formed in the taper section 54. Accordingly, when the visible light in the TM0 mode is incident on the incident end 54a, an interaction occurs between the TM0 mode and the TE1 mode in the above-described region. As a result, the polarization mode of the visible light is converted from the TM0 mode to the TE1 mode, and the visible light in the TE1 mode is emitted from the emission end 54b.

Further, the region where the effective refractive index N_{TE1_1} in the line section 55 and the effective refractive index N_{TE0_2} in the line section 56 are substantially equal to each other is formed between the incident end 60a (position X2) and the position X3 of the asymmetrical directional coupler 60. Accordingly, when the visible light in the TE1 mode is incident on the incident end 60a, an interaction occurs between the TE1 mode and the TE0 mode in the above-described region. As a result, the polarization mode of the visible light is converted from the TE1 mode to the TE0 mode, and the visible light in the TE0 mode is emitted from the emission end 60b. As described above, the polarization mode of the visible light can be converted from the TM0 mode to the TE0 mode.

The near-eye wearable device 1 includes the retinal projection device 10, and the retinal projection device 10 includes the optical element 30. Accordingly, in the near-eye wearable device 1 and the retinal projection device 10, it is possible to project an image onto the retina after converting the polarization mode of the visible light from the TM0 mode to the TE0 mode.

Also between the position X3 and the emission end 60b (position X4), the region in which the effective refractive index N_{TE1_1} in the line section 55 and the effective refractive index N_{TE0_2} in the line section 56 are substantially equal to each other is formed, so that an interaction occurs between the TE1 mode and the TE0 mode. Accordingly, the number of conversions from the TE1 mode to the TE0 mode can be increased, and the conversion efficiency from the TE1 mode to the TE0 mode can be improved.

The width of the line section 55 may increase from the incident end 60a (position X2) toward the position X3, and the width of the line section 56 may increase from the incident end 60a (position X2) toward the position X3. According to this configuration, both the effective refractive index N_{TE1_1} and the effective refractive index N_{TE0_2} increase from the position X2 toward the position X3. Therefore, the angle formed by the curve representing the relationship between the position in the X-axis direction and the effective refractive index N_{TE1_1} and the curve representing the relationship between the position in the X-axis direction and the effective refractive index N_{TE0_2} can be reduced, as compared with the configuration in which either the effective refractive index N_{TE1_1} or the effective refractive index N_{TE0_2} is constant over the range from the position X2 to the position X3. This makes it possible to improve the conversion efficiency from the TE1 mode to the TE0 mode.

In the red light having a relatively long wavelength in the visible light band, the overlap of the mode profiles of the two polarization modes that interact with each other is large, and mode coupling is likely to occur. Accordingly, it is not necessary to increase the length L2 for the red light. Therefore, by adopting the configuration in which the width of the line section 55 increases from the incident end 60a (position X2) toward the position X3 and the width of the line section 56 increases from the incident end 60a (position X2) toward the position X3, the conversion efficiency from the TE1 mode to the TE0 mode can be improved without increasing the length L2.

The width of the line section 55 may increase from the incident end 60a (position X2) toward the position X3, and the width of the line section 56 may be constant over the range from the incident end 60a (position X2) to the position X3. According to this configuration, the effective refractive index N_{TE1_1} increases from the position X2 toward the position X3, while the effective refractive index N_{TE0_2} is constant over the range from the position X2 to the position X3. Therefore, by increasing the length L2, it is possible to reduce the angle formed by the curve representing the relationship between the position in the X-axis direction and the effective refractive index N_{TE1_1} and the curve representing the relationship between the position in the X-axis direction and the effective refractive index N_{TE0_2}. This makes it possible to improve the conversion efficiency from the TE1 mode to the TE0 mode.

In the green light and the blue light, which have relatively short wavelengths in the visible light band, the overlap of the mode profiles of the two polarization modes that interact with each other is smaller than that of the red light, and mode coupling is less likely to occur. Accordingly, it is necessary to make the length L2 longer for the green light and the blue light than for the red light. Therefore, by adopting a configuration in which the width of the line section 55 increases from the incident end 60a (position X2) toward the position X3 and the width of the line section 56 is constant over the range from the incident end 60a (position X2) to the position X3, it is possible to improve the conversion efficiency from the TE1 mode to the TE0 mode while increasing the length L2.

Each of the mode converters 35R, 35G, and 35B includes the slab 53. Accordingly, since the taper section 54 has an asymmetric shape in the Z-axis direction, the conversion efficiency from the TM0 mode to the TE1 mode by the taper section 54 can be improved. Here, the term “asymmetric in the Z-axis direction” means that, with respect to a symmetry plane that passes through the center of the taper section 54 in the Z-axis direction and is orthogonal to the Z-axis direction, two portions separated by the symmetry plane are not plane-symmetric. Furthermore, the optical coupling between the waveguides 51 and 52 is made stronger by the visible light seeping out from the waveguides 51 and 52 to the slab 53. Accordingly, the conversion efficiency from the TE1 mode to the TE0 mode by the asymmetrical directional coupler 60 can be improved.

The heights (heights Tc) of the mode converters 35R, 35G, and 35B are smaller than the wavelengths of visible light to be converted. Specifically, the height of the mode converter 35R is smaller than the wavelength of the red light, the height of the mode converter 35G is smaller than the wavelength of the green light, and the height of the mode converter 35B is smaller than the wavelength of the blue light. According to this configuration, the visible light is likely to seep out from the waveguides 51 and 52 to the slab 53. Accordingly, the optical coupling between the waveguide 51 and the waveguide 52 by the slab 53 can be made stronger. Accordingly, the conversion efficiency from the TE1 mode to the TE0 mode by the asymmetrical directional coupler 60 can be further improved.

The cross-sectional shape of the waveguide 51 intersecting (orthogonal to) the X-axis direction is a trapezoidal shape whose length in the Y-axis direction increases toward the main surface 31a in the Z-axis direction. Accordingly, since the waveguide 51 has an asymmetric shape in the Z-axis direction, the conversion efficiency from the TM0 mode to the TE1 mode by the taper section 54 can be improved. In addition to the waveguide 51, the cross-sectional shape of the waveguide 52 intersecting (orthogonal to) the X-axis direction is a trapezoidal shape whose length in the Y-axis direction increases toward the main surface 31a in the Z-axis direction. According to this configuration, the overlap of the mode profiles of the two polarization modes (TE0 mode and TE1 mode) that interact with each other in the asymmetrical directional coupler 60 becomes large, and mode coupling is likely to occur. Accordingly, the conversion efficiency from the TE1 mode to the TE0 mode can be further improved.

The multiplexer 36 is designed such that the multiplexing efficiency in the case of multiplexing the red light, the green light, and the blue light in the TE0 mode is higher than the multiplexing efficiency in the case of multiplexing the red light, the green light, and the blue light in the TM0 mode. In the near-eye wearable device 1, the retinal projection device 10, the laser module 13, and the optical element 30, the mode converter 35R converts the polarization mode of the red light from the TM0 mode to the TE0 mode, the mode converter 35G converts the polarization mode of the green light from the TM0 mode to the TE0 mode, and the mode converter 35B converts the polarization mode of the blue light from the TM0 mode to the TE0 mode. Accordingly, the multiplexing efficiency in the multiplexer 36 can be improved.

The height of the mode converter 35R, the height of the mode converter 35G, and the height of the mode converter 35B are the same as each other. According to this configuration, the mode converter 35R, the mode converter 35G, and the mode converter 35B can be formed on the same substrate 31, and the height of each mode converter can be made the same, so that the optical element 30 can be easily manufactured.

In order to output full-color laser light by multiplexing the red light, the green light, and the blue light, it is necessary to adjust the light intensity of light of each color corresponding to the output color. In order to change the light intensity of each color light in the light source unit 20, a large drive current is required. In the near-eye wearable device 1, the retinal projection device 10, the laser module 13, and the optical element 30, the light intensity of the red light is modulated by the modulator 34R, the light intensity of the green light is modulated by the modulator 34G, and the light intensity of the blue light is modulated by the modulator 34B. Accordingly, full-color laser light can be output without requiring a large drive current.

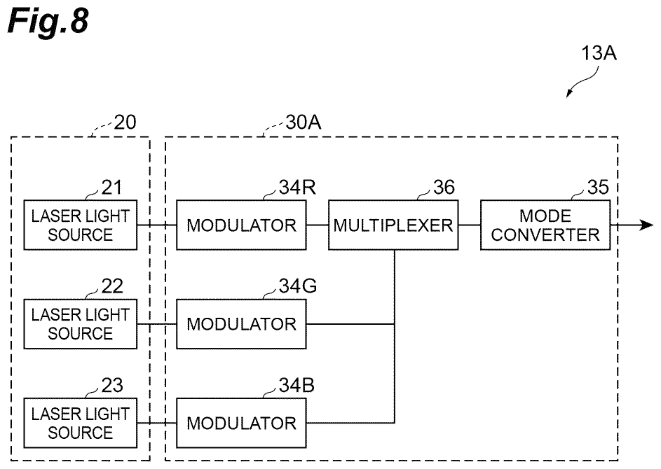

Next, a laser module according to another embodiment will be described with reference to FIG. 8. FIG. 8 is a block diagram of a laser module according to another embodiment. The laser module 13A shown in FIG. 8 is mainly different from the laser module 13 in that the laser module 13A includes an optical element 30A instead of the optical element 30. The optical element 30A is mainly different from the optical element 30 in that the optical element 30A includes one mode converter 35 instead of the mode converter 35R, the mode converter 35G, and the mode converter 35B, and that the multiplexer 36 is disposed between each of the modulators and the mode converter 35.

Specifically, the multiplexer 36 is provided subsequent to the modulators 34R, 34G, and 34B, and multiplexes the red light emitted from the modulator 34R, the green light emitted from the modulator 34G, and the blue light emitted from the modulator 34B into a single laser light to emit the laser light. The multiplexer 36 emits the laser light to the mode converter 35.

The mode converter 35 is provided subsequent to the multiplexer 36, and converts the polarization mode of the laser light emitted from the multiplexer 36 from the TM0 mode to the TE0 mode. The configuration of the mode converter 35 is the same as that of the mode converter 35B.

In the laser module 13A, visible light in the TM0 mode is emitted from each laser light source, and the light intensity of the visible light in the TM0 mode is modulated by each modulator. The visible light modulated by each modulator is multiplexed by the multiplexer 36 to generate laser light. Then, the polarization mode of the laser light is converted from the TM0 mode to the TE0 mode by the mode converter 35, and the laser light in the TE0 mode is emitted from the mode converter 35 to the optical components 14 (refer to FIG. 2).

Also in the laser module 13A, the same effects as those of the laser module 13 can be obtained in the configuration common to the laser module 13. Also in the optical element 30A, the same effects as those of the optical element 30 can be obtained in the configuration common to the optical element 30. Since the laser module 13A and the optical element 30A include one mode converter 35 instead of the mode converter 35R, the mode converter 35G, and the mode converter 35B, the laser module 13A and the optical element 30A can be reduced in size.

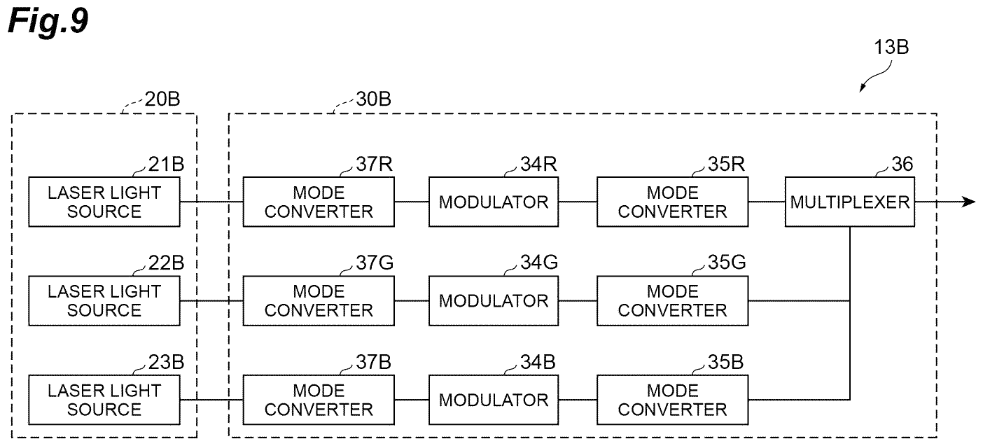

Next, a laser module according to still another embodiment will be described with reference to FIG. 9. FIG. 9 is a block diagram of a laser module according to still another embodiment. The laser module 13B shown in FIG. 9 is mainly different from the laser module 13 in that the laser module 13B includes a light source unit 20B and an optical element 30B instead of the light source unit 20 and the optical element 30. The light source unit 20B is mainly different from the light source unit 20 in that the light source unit 20B includes laser light sources 21B, 22B, and 23B instead of the laser light sources 21, 22, and 23.

The laser light sources 21B, 22B, and 23B are mainly different from the laser light source 21, 22, and 23 in the polarization mode of the visible light to be emitted. Specifically, the laser light source 21B emits red light in the TE0 mode. The laser light source 22B emits green light in the TE0 mode. The laser light source 23B emits blue light in the TE0 mode.

The optical element 30B is mainly different from the optical element 30 in that the optical element 30B further includes a mode converter 37R, a mode converter 37G, and a mode converter 37B.

The mode converter 37R is a mode converter for converting the polarization mode of the red light from the TE0 mode to the TM0 mode. The mode converter 37R converts the polarization mode of the red light emitted from the laser light source 21B from the TE0 mode to the TM0 mode, and emits the red light in the TM0 mode to the modulator 34R.

The mode converter 37G is a mode converter for converting the polarization mode of the green light from the TE0 mode to the TM0 mode. The mode converter 37G converts the polarization mode of the green light emitted from the laser light source 22B from the TE0 mode to the TM0 mode, and emits the green light in the TM0 mode to the modulator 34G.

The mode converter 37B is a mode converter for converting the polarization mode of the blue light from the TE0 mode to the TM0 mode. The mode converter 37B converts the polarization mode of the blue light emitted from the laser light source 23B from the TE0 mode to the TM0 mode, and emits the blue light in the TM0 mode to the modulator 34B.

As each of the mode converters 37R, 37G, and 37B, for example, a configuration in which the incident end and the emission end of each of the mode converters 35R, 35G, and 35B are interchanged is adopted. In this configuration, the visible light in the TE0 mode is incident on the other end 56b of the line section 56, an interaction occurs between the TE0 mode in the line section 56 and the TE1 mode in the line section 55, the polarization mode of the visible light is converted from the TE0 mode to the TE1 mode, and the visible light in the TE1 propagates through the line section 55. Then, the visible light in the TE1 mode is emitted from the one end 55a of the line section 55 to the emission end 54b of the taper section 54. When the visible light in the TE1 mode is incident on the emission end 54b of the taper section 54, the visible light propagates through the taper section 54. Then, an interaction occurs between the TE1 mode and the TM0 mode, and the polarization mode of the visible light is converted from the TE1 mode to the TM0 mode. Then, the visible light in the TM0 mode is emitted from the incident end 54a.

In the laser module 13B, since the visible light in the TE0 mode is emitted from each laser light source, first, the polarization mode of each visible light emitted from each laser light source is converted from the TE0 mode to the TM0 mode by each of the mode converters 37R, 37G, and 37B. Then, after the light intensity of the visible light in the TM0 mode is modulated by each modulator, the polarization mode of each of the modulated visible light is converted from the TM0 mode to the TE0 mode by each of the mode converters 35R, 35G, and 35B. Then, each visible light is multiplexed by the multiplexer 36 to be emitted from the multiplexer 36 to the optical components 14 (refer to FIG. 2) as the laser light in the TE0 mode.

Also in the laser module 13B, the same effects as those of the laser module 13 can be obtained in the configuration common to the laser module 13. Also in the optical element 30B, the same effects as those of the optical element 30 can be obtained in the configuration common to the optical element 30. In the laser module 13B and the optical element 30B, the visible light in the TE0 mode is emitted from each of the laser light sources. Even in this case, the visible light in the TE0 mode can be emitted to the outside without lowering the modulation efficiency of each modulator.

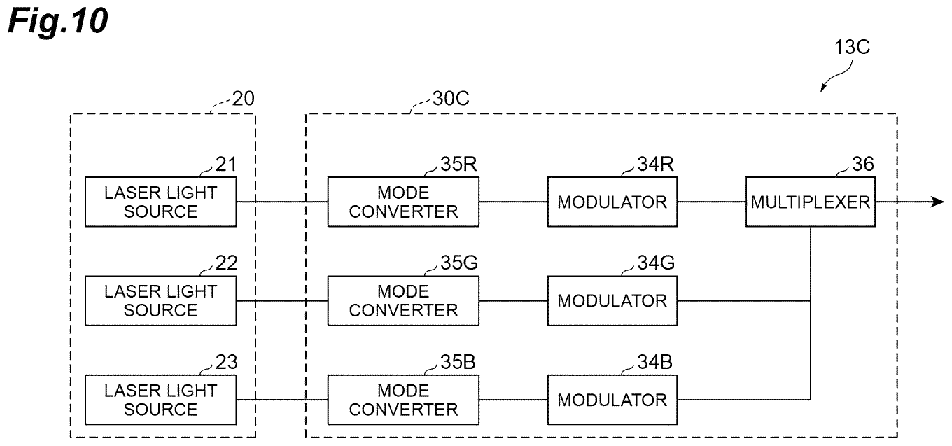

Next, a laser module according to still another embodiment will be described with reference to FIG. 10. FIG. 10 is a block diagram of a laser module according to still another embodiment. The laser module 13C is mainly different from the laser module 13 in that the laser module 13C includes an optical element 30C instead of the optical element 30. The optical element 30C is mainly different from the optical element 30 in the direction of the C-axis of the lithium niobate constituting the core layer 32 and that the positions of the modulators 34R, 34G, and 34B and the mode converters 35R, 35G, and 35B are interchanged.

In the present embodiment, the C-axis of the lithium niobate extends in the Y-axis direction. The core layer 32 is made of, for example, X-cut lithium niobate.

The mode converter 35R converts the polarization mode of the red light emitted from the laser light source 21 from the TM0 mode to the TE0 mode, and emits the red light in the TE0 mode to the modulator 34R. The mode converter 35G converts the polarization mode of the green light emitted from the laser light source 22 from the TM0 mode to the TE0 mode, and emits the green light in the TE0 mode to the modulator 34G. The mode converter 35B converts the polarization mode of the blue light emitted from the laser light source 23 from the TM0 mode to the TE0 mode, and emits the blue light in the TE0 mode to the modulator 34B.

The modulator 34R is provided subsequent to the mode converter 35R, and modulates the light intensity of the red light in the TE0 mode emitted from the mode converter 35R to emit the modulated red light to the multiplexer 36. The modulator 34G is provided subsequent to the mode converter 35G, and modulates the light intensity of the green light in the TE0 mode emitted from the mode converter 35G to emit the modulated green light to the multiplexer 36. The modulator 34B is provided subsequent to the mode converter 35B, and modulates the light intensity of the blue light in the TE0 mode emitted from the mode converter 35B to emit the modulated blue light to the multiplexer 36. As described above, the C-axis of the lithium niobate extends in the Y-axis direction. Accordingly, the modulation efficiency of each modulator is improved in the TE mode.

In the laser module 13C, since the visible light in the TM0 mode is emitted from each laser light source, the polarization mode of each visible light emitted from each laser light source is converted from the TM0 mode to the TE0 mode by each mode converter. Then, after the light intensity of the visible light in the TE0 mode is modulated by each modulator, the modulated visible light is multiplexed by the multiplexer 36 to be emitted from the multiplexer 36 to the optical components 14 (refer to FIG. 2) as the laser light in the TE0 mode.

Also in the laser module 13C, the same effects as those of the laser module 13 can be obtained in the configuration common to the laser module 13. Also in the optical element 30C, the same effects as those of the optical element 30 can be obtained in the configuration common to the optical element 30.

The optical element, the laser module, the retinal projection device, and the near-eye wearable device according to the present disclosure are not limited to the above-described embodiments.

For example, each of the laser modules 13, 13A, 13B, and 13C may be applied to devices other than the near-eye wearable device 1.

The optical elements 30, 30A, 30B, and 30C are not required to include the cladding layer 33. In this case, the air layer can function as the upper cladding layer.

The optical elements 30, 30A, 30B, and 30C only need to include one mode converter. In other words, the core layer 32 only needs to include one mode converter for converting the polarization mode of the visible light from the TM0 mode to the TE0 mode.

The mode converter 35R is not required to include the slab 53. The mode converter 35G is not required to include the slab 53. The mode converter 35B is not required to include the slab 53. The height of the mode converter 35R, the height of the mode converter 35G, and the height of the mode converter 35B may be different from each other.

It is sufficient that the effective refractive index N_{TM0_1} and the effective refractive index N_{TE1_1} are equal to each other at a certain position between the incident end 54a (position X1) and the emission end 54b (position X2), and that both the effective refractive index N_{TM0_1} and the effective refractive index N_{TE1_1} are separated from the effective refractive indices of other polarization modes throughout the region between the incident end 54a (position X1) and the emission end 54b (position X2). Within the range in which the above condition is satisfied, the taper section 54 can be appropriately changed.

It is sufficient that the effective refractive index N_{TE1_1} and the effective refractive index N_{TE0_2} are equal to each other at a certain position between the incident end 60a (position X2) and the position X3, and both the effective refractive index N_{TE1_1} and the effective refractive index N_{TE0_2} are separated from the effective refractive indices of other polarization modes throughout the region between the incident end 60a (position X2) and the position X3. Within the range in which the above condition is satisfied, the conversion region 61 can be appropriately changed.

It is sufficient that the effective refractive index N_{TE1_1} and the effective refractive index N_{TE0_2} are equal to each other at a certain position between the position X3 and the emission end 60b (position X4), and both the effective refractive index N_{TE1_1} and the effective refractive index N_{TE0_2} are separated from the effective refractive indices of other polarization modes throughout the region between the position X3 and the emission end 60b (position X4). Within the range in which the above condition is satisfied, the conversion region 62 can be appropriately changed.

### Examples

Hereinafter, the present disclosure will be described in more detail with reference to Examples in order to explain the above effects. The present disclosure is not limited to these examples.

The conversion losses in the mode converters of Examples 1 to 3 were calculated. The conversion loss here means a loss in the conversion from the TM0 mode to the TE0 mode. As the mode converters of Examples 1 to 3, mode converters having the same structure as that of the mode converter 35B shown in FIGS. 5 and 6 were used. In Examples 1 to 3, sapphire was used as the constituent material of the substrate 31, lithium niobate (LiNbO₃) was used as the constituent material of the core layer 32, and silicon dioxide (SiO₂) was used as the constituent material of the cladding layer 33.

As shown in Table 1, in Examples 1 to 3, the height Tc was set to 0.45 μm, the height Ts was set to 0.15 μm, and the inclination angle θ was set to 70°. The width W11 and the width W12 were set such that a region in which the effective refractive index N_{TM0_1} and the effective refractive index N_{TE1_1} were substantially equal to each other was positioned near the center of the taper section 54 in the X-axis direction. The width W13, the width W14, the width W22, the width W23, the width W24, the distance D, the minimum gap G, the length L1, the length L2, and the length L3 were set such that length Lt was 1000 μm or less and conversion loss was 0.5 dB or less. The mode converters of Examples 1 and 2 did not include the conversion region 62. In the conversion region 61 of the mode converter of Example 1, the width of the line section 56 continuously increased from the incident end 60a toward the position X3. In the conversion regions 61 of the mode converters of Examples 2 and 3, the widths of the line sections 56 were constant over the range from the incident end 60a to the position X3. A wavelength of 638 μm was used for red light, a wavelength of 520 μm was used for green light, and a wavelength of 455 μm was used for blue light.

TABLE 1

| | Example 1 | Example 2 | Example 3 |
|---|---|---|---|
| Color | Red | Green | Blue |
| Tc [μm] | 0.45 | 0.45 | 0.45 |
| Ts [μm] | 0.15 | 0.15 | 0.15 |
| θ [deg] | 70 | 70 | 70 |
| W11 [μm] | 0.70 | 0.60 | 0.45 |
| W12 [μm] | 0.90 | 0.80 | 0.60 |
| W13 [μm] | 1.00 | 0.90 | 0.80 |
| W14 [μm] | — | — | 0.70 |
| W22 [μm] | 0.40 | 0.40 | 0.30 |
| W23 [μm] | 0.50 | 0.40 | 0.30 |
| W24 [μm] | — | — | 0.40 |
| D [μm] | 1.00 | 0.90 | 0.80 |
| G [μm] | 0.25 | 0.25 | 0.25 |
| L1 [μm] | 300 | 300 | 200 |
| L2 [μm] | 361 | 471 | 412 |
| L3 [μm] | — | — | 200 |
| Lt [μm] | 661 | 771 | 812 |
| Conversion Loss | 0.06 | 0.47 | 0.24 |
| [dB] | | | |

In the mode converters of Examples 1 to 3, a relatively low conversion loss of 0.06 dB to 0.47 dB occurred. The length Lt was 661 μm to 812 μm. From these, it can be understood low-loss mode conversion is achieved with the shortening of the length Lt.

### <Evaluation of Presence or Absence of Slab>

Using Examples 1 to 6, the influence of the presence or absence of the slab on the conversion loss was evaluated. As the taper sections of Examples 4 to 6, taper sections having the same structure as those of the taper sections of Examples 1 to 3 except that the taper sections did not include any slab were used. Similarly to Examples 1 to 3, in Examples 4 to 6, sapphire was used as the constituent material of the substrate 31, lithium niobate (LiNbO₃) was used as the constituent material of the core layer 32, and silicon dioxide (SiO₂) was used as the constituent material of the cladding layer 33.

As shown in Table 2, in Examples 1 to 6, the height Tc was set to 0.45 μm and the inclination angle θ was set to 70°. In Examples 1 to 3, the height Ts was set to 0.15 μm, and in Examples 4 to 6, the height Ts was set to 0 μm. That is, in Examples 4 to 6, the taper sections 54 did not include the slab 53 and were composed of only the waveguides 51 and 52. In order to compare the conversion loss under the same condition as much as possible, the width W11 and the width W12 were set such that a region where the effective refractive index N_{TM0_1} and the effective refractive index N_{TE1_1} were substantially equal to each other was positioned near the center of the taper section 54 in the X-axis direction.

The effective refractive index N_{TE1_1} is lower in the taper section 54 not including the slab 53 than in the taper section 54 including the slab 53. Therefore, the width W12 is slightly different between Example 2 and Example 5. Similarly, the width W12 is slightly different between Example 3 and Example 6. A wavelength of 638 μm was used for red light, a wavelength of 520 μm was used for green light, and a wavelength of 455 μm was used for blue light.

TABLE 2

| | Example 1 | Example 2 | Example 3 | Example 4 | Example 5 | Example 6 |
|---|---|---|---|---|---|---|
| Color | Red | Green | Blue | Red | Green | Blue |
| Tc [μm] | 0.45 | 0.45 | 0.45 | 0.45 | 0.45 | 0.45 |
| Ts [μm] | 0.15 | 0.15 | 0.15 | 0 | 0 | 0 |
| θ [deg] | 70 | 70 | 70 | 70 | 70 | 70 |
| W11 [μm] | 0.70 | 0.60 | 0.45 | 0.70 | 0.60 | 0.45 |
| W12 [μm] | 0.90 | 0.80 | 0.60 | 0.90 | 0.90 | 0.70 |
| Conversion | 0.01 | 0.01 | 0.03 | 1.36 | 1.15 | 1.91 |
| Loss [dB] | | | | | | |

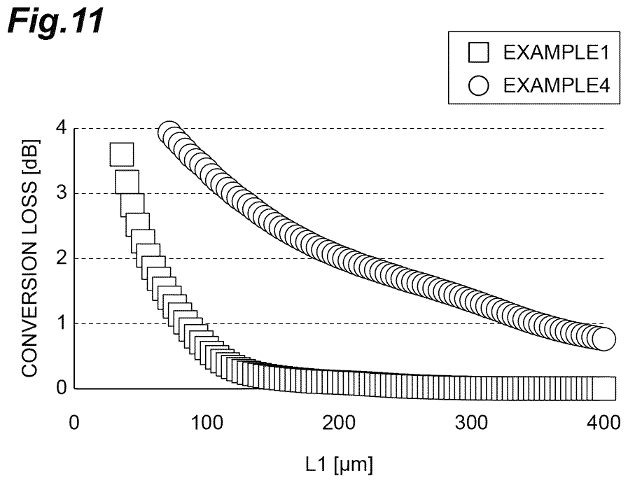

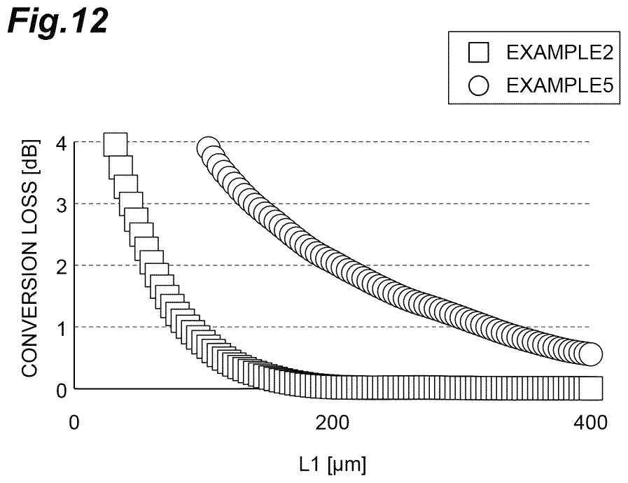

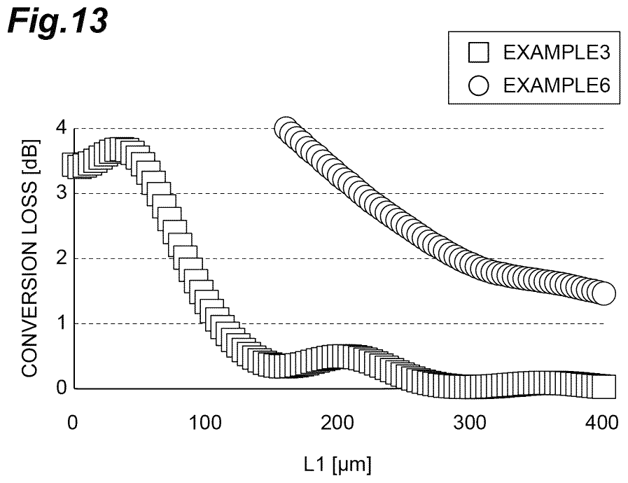

In the taper section 54 in which the values of the parameters shown in Table 2 were set, the conversion loss was calculated while changing the length L1. The conversion loss is a loss in the conversion from the TM0 mode to the TE1 mode. The calculation results of the conversion loss are shown in FIGS. 11 to 13. FIG. 11 is a diagram showing calculation results of conversion loss of red light in the taper section. FIG. 12 is a diagram showing calculation results of conversion loss of green light in the taper section. FIG. 13 is a diagram showing calculation results of conversion loss of blue light in the taper section. The horizontal axes in FIGS. 11 to 13 indicate the length L1 (unit: μm). The vertical axes in FIGS. 11 to 13 indicate the conversion loss (unit: dB).

According to FIGS. 11 to 13, the length L1 required to achieve the same conversion loss for light of any color is shorter in the taper section 54 including the slab 53 than in the taper section 54 not including the slab 53. Accordingly, it has been confirmed that the length L1 for achieving the desired conversion loss can be shortened and the length Lt can be shortened by the taper section 54 including the slab 53.

Table 2 shows the conversion loss at a length L1 of 300 μm. When the lengths L1 are set to the same length, the conversion loss of the taper section 54 including the slab 53 is lower than the conversion loss of the taper section 54 not including the slab 53 for light of any color. Accordingly, it has been confirmed that the reduction of the conversion efficiency is suppressed by the taper section 54 including the slab 53.

### <Evaluation of Height of Mode Converter>

Using Examples 1 and 7 to 9, the influence of the height Tc on the conversion loss was evaluated. As the mode converters of Examples 7 to 9, mode converters having the same structure as that of the mode converter of Example 1 were used. Similarly to Example 1, in Examples 7 to 9, sapphire was used as the constituent material of the substrate 31, lithium niobate (LiNbO₃) was used as the constituent material of the core layer 32, and silicon dioxide (SiO₂) was used as the constituent material of the cladding layer 33.

As shown in Table 3, in Examples 1 and 7 to 9, the height Ts was set to 0.15 μm and the inclination angle θ was set to 70°. In Examples 1 and 7 to 9, the height Tc was set to different values. In order to compare the conversion loss under the same condition as much as possible, the width W11 and the width W12 were set such that a region where the effective refractive index N_{TM0_1} and the effective refractive index N_{TE1_1} were substantially equal to each other was positioned near the center of the taper section 54 in the X-axis direction. In Examples 7 and 8, the width W13, the width W22, the width W23, the distance D, the minimum gap G, the length L1, and the length L2 were set such that the length Lt was 2,000 μm or less and the conversion loss was 0.5 dB or less. In Example 9, the width W13, the width W22, the width W23, the distance D, the minimum gap G, the length L1, and the length L2 were set such that the length Lt was 40,000 μm or less and the conversion loss was minimized. A wavelength of 638 μm was used for red light.

TABLE 3

| | Example 1 | Example 7 | Example 8 | Example 9 |
|---|---|---|---|---|
| Color | Red | Red | Red | Red |
| Tc [μm] | 0.45 | 0.60 | 0.80 | 1.00 |
| Ts [μm] | 0.15 | 0.15 | 0.15 | 0.15 |
| θ [deg] | 70 | 70 | 70 | 70 |
| W11 [μm] | 0.70 | 0.80 | 0.90 | 0.80 |
| W12 [μm] | 0.90 | 1.00 | 1.10 | 1.20 |
| W13 [μm] | 1.00 | 1.10 | 1.20 | 1.40 |
| W22 [μm] | 0.40 | 0.50 | 0.60 | 0.70 |
| W23 [μm] | 0.50 | 0.60 | 0.60 | 0.70 |
| D [μm] | 1.00 | 1.00 | 1.00 | 1.20 |
| G [μm] | 0.25 | 0.15 | 0.10 | 0.15 |
| L1 [μm] | 300 | 500 | 600 | 965 |
| L2 [μm] | 361 | 1000 | 600 | 39000 |
| Lt [μm] | 661 | 1500 | 1200 | 39965 |
| Conversion Loss | 0.06 | 0.07 | 0.12 | 1.75 |
| [dB] | | | | |

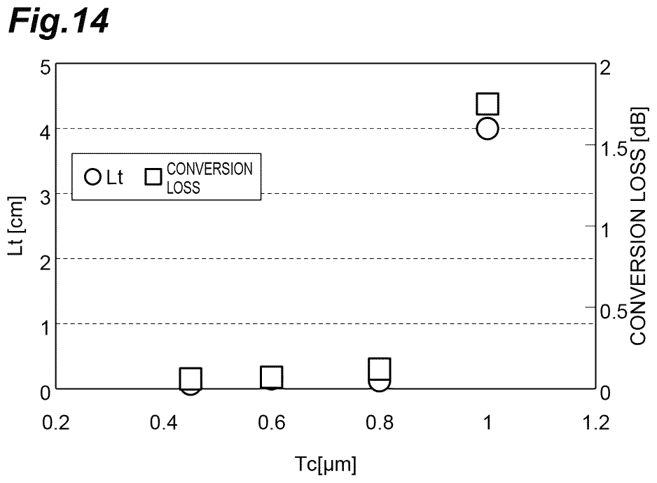

The conversion loss was calculated in the mode converter in which the values of the parameters shown in Table 3 were set. The conversion loss is a loss in the conversion from the TM0 mode to the TE0 mode. The calculation results of the conversion loss are shown in FIG. 14. FIG. 14 is a diagram showing the relationship between the height of the mode converter, the length of the mode converter in the X-axis direction, and the conversion loss. The horizontal axis in FIG. 14 indicates the height Tc (unit: μm). The vertical axis on the left side in FIG. 14 indicates the length Lt (unit: cm). The vertical axis on the right side in FIG. 14 indicates the conversion loss (unit: dB).

According to Table 3 and FIG. 14, a conversion loss of 2 dB or less is achieved at any height Tc without increasing the length Lt. When the height Tc is 0.8 μm or less, the length Lt is significantly shorter and the conversion loss is significantly reduced as compared with the case where the height Tc is 1.0 μm. It can be understood that when the height Tc is equal to or less than the wavelength (638 μm) of the red light, the conversion loss can be further suppressed while further shortening the length Lt.

### <Evaluation of Inclination Angle>

Using Examples 1 and 10 to 12, the influence of the inclination angle θ on the conversion loss was evaluated. As the mode converters of Examples 10 to 12, mode converters having the same structure as that of the mode converter of Example 1 were used. Similarly to Example 1, in Examples 10 to 12, sapphire was used as the constituent material of the substrate 31, lithium niobate (LiNbO₃) was used as the constituent material of the core layer 32, and silicon dioxide (SiO₂) was used as the constituent material of the cladding layer 33.

As shown in Table 4, in Examples 1 and 10 to 12, the height Tc was set to 0.45 μm and the height Ts was set to 0.15 μm. In Examples 1 and 10 to 12, the inclination angle θ was set to different values. In order to compare the conversion loss under the same condition as much as possible, the width W11 and the width W12 were set such that a region where the effective refractive index N_{TM0_1} and the effective refractive index N_{TE1_1} were substantially equal to each other was positioned near the center of the taper section 54 in the X-axis direction. The width W13, the width W22, the width W23, the distance D, the minimum gap G, the length L1, and the length L2 were set such that the minimum gap G was 0.2 μm or more and the conversion loss was 1.0 dB or less. A wavelength of 638 μm was used for red light.

TABLE 4

| | Example 1 | Example 10 | Example 11 | Example 12 |
|---|---|---|---|---|
| Color | Red | Red | Red | Red |
| Tc [μm] | 0.45 | 0.45 | 0.45 | 0.45 |
| Ts [μm] | 0.15 | 0.15 | 0.15 | 0.15 |
| θ [deg] | 70 | 80 | 86 | 90 |
| W11 [μm] | 0.70 | 0.70 | 0.70 | 0.70 |
| W12 [μm] | 0.90 | 0.90 | 0.90 | 1.00 |
| W13 [μm] | 1.00 | 1.00 | 1.00 | 1.00 |
| W22 [μm] | 0.40 | 0.40 | 0.40 | 0.40 |
| W23 [μm] | 0.50 | 0.60 | 0.60 | 0.60 |
| D [μm] | 1.00 | 1.00 | 1.00 | 1.00 |
| G [μm] | 0.25 | 0.20 | 0.20 | 0.20 |
| L1 [μm] | 300 | 500 | 650 | 800 |
| L2 [μm] | 361 | 975 | 1350 | 2000 |
| Lt [μm] | 661 | 1475 | 2000 | 2800 |
| Conversion | 0.987 | 0.899 | 0.893 | 0.855 |
| Efficiency | | | | |
| Conversion Loss | 0.06 | 0.46 | 0.49 | 0.68 |
| [dB] | | | | |

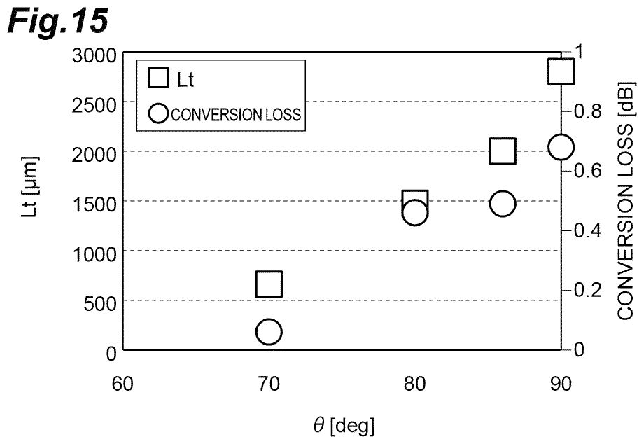

The conversion loss was calculated in the mode converter in which the values of the parameters shown in Table 4 were set. The conversion loss is a loss in the conversion from the TM0 mode to the TE0 mode. The calculation results of the conversion loss are shown in FIG. 15. FIG. 15 is a diagram showing the relationship between the inclination angle, the length of the mode converter in the X-axis direction, and the conversion loss. The horizontal axis in FIG. 15 indicates the inclination angle θ (unit: deg). The vertical axis on the left side in FIG. 15 indicates the length Lt (unit: μm). The vertical axis on the right side in FIG. 15 indicates the conversion loss (unit: dB).

According to Table 4 and FIG. 15, at any inclination angle θ, a conversion efficiency of 85% or more (conversion loss of 0.7 dB or less) is achieved without increasing the length Lt. The conversion efficiency represents the light intensity of the visible light in the TE0 mode emitted from the emission end 60b when the light intensity of the visible light in the TM0 mode incident on the incident end 54a is set to 1. The conversion loss is obtained by converting the conversion efficiency into dB units. It has been confirmed that the conversion loss is suppressed when the inclination angle θ is smaller than 90°, even if the length Lt is short, as compared with the case where the inclination angle θ is 90°. In other words, it can be understood that when the cross-sectional shapes of the waveguides 51 and 52 orthogonal to the X-axis direction are a trapezoidal shape, the conversion loss can be suppressed while shortening the length Lt as compared with the case where the cross-sectional shape is a rectangular shape.

### (Additional Statements)

### [Clause 1]

An optical element comprising:
a substrate including a main surface; and
a core layer provided on the main surface and made of a material having an electro-optic effect,
wherein the core layer comprises a mode converter configured to convert a polarization mode of visible light from a TM0 mode to a TE0 mode,
wherein the mode converter comprises:
a first waveguide extending in a first direction along the main surface; and
a second waveguide extending in the first direction,
wherein the first waveguide comprises:
a taper section including a first incident end on which the visible light is incident and a first emission end from which the visible light is emitted, the taper section having a length in a second direction along the main surface and intersecting the first direction that increases from a first length at the first incident end to a second length toward the first emission end; and
a first line section through which the visible light emitted from the first emission end propagates,
wherein the second waveguide comprises a second line section arranged side by side with the first line section in the second direction,
wherein the first length is a length at which a first effective refractive index, which is an effective refractive index of the TM0 mode, is higher than a second effective refractive index, which is an effective refractive index of a TE1 mode,
wherein the second length is a length at which the first effective refractive index is lower than the second effective refractive index,
wherein the first line section and the second line section constitute an asymmetrical directional coupler,
wherein the asymmetrical directional coupler includes a second incident end and a second emission end which are both ends in the first direction, and
wherein a length of the first line section in the second direction and a length of the second line section in the second direction are set such that a magnitude relationship between the second effective refractive index in the first line section and a third effective refractive index, which is an effective refractive index of the TE0 mode, in the second line section at a position different from the second incident end of the asymmetrical directional coupler is inverted to a magnitude relationship between the second effective refractive index in the first line section and the third effective refractive index in the second line section at the second incident end.

### [Clause 2]

The optical element according to clause 1,
wherein the length of the first line section in the second direction increases from the second incident end toward the position, and
wherein the length of the second line section in the second direction increases from the second incident end toward the position.

### [Clause 3]

The optical element according to clause 1,
wherein the length of the first line section in the second direction increases from the second incident end toward the position, and
wherein the length of the second line section in the second direction is constant over a range from the second incident end to the position.

### [Clause 4]

The optical element according to any one of clauses 1 to 3,
wherein the length of the first line section in the second direction and the length of the second line section in the second direction are set such that a magnitude relationship between the second effective refractive index in the first line section and the third effective refractive index in the second line section at the second emission end is inverted to a magnitude relationship between the second effective refractive index in the first line section and the third effective refractive index in the second line section at the position.

### [Clause 5]

The optical element according to any one of clauses 1 to 4,
wherein the mode converter further comprises a flat plate-shaped slab on which the first waveguide and the second waveguide are provided.

### [Clause 6]

The optical element according to clause 5,
wherein a length of the mode converter in a third direction intersecting the first direction and the second direction is smaller than a wavelength of the visible light.

### [Clause 7]

The optical element according to any one of clauses 1 to 6,
wherein a cross-sectional shape of the first waveguide intersecting the first direction is a trapezoidal shape whose length in the second direction increases toward the main surface.

### [Clause 8]

The optical element according to any one of clauses 1 to 7,
wherein the core layer comprises:
a first mode converter which is the mode converter configured to convert a polarization mode of red light from the TM0 mode to the TE0 mode;
a second mode converter which is the mode converter configured to convert a polarization mode of green light from the TM0 mode to the TE0 mode;
a third mode converter which is the mode converter configured to convert a polarization mode of blue light from the TM0 mode to the TE0 mode; and
a multiplexer configured to multiplex the red light, the green light, and the blue light to emit laser light.

### [Clause 9]

The optical element according to clause 8,
wherein a length of the first mode converter in a third direction intersecting the first direction and the second direction, a length of the second mode converter in the third direction, and a length of the third mode converter in the third direction are equal to each other.

### [Clause 10]

The optical element according to clause 8 or 9,
wherein the core layer further comprises:
a first modulator configured to modulate light intensity of the red light;
a second modulator configured to modulate light intensity of the green light; and
a third modulator configured to modulate light intensity of the blue light.

### [Clause 11]

A laser module comprising:
the optical element according to any one of clauses 8 to 10;
a first light source configured to emit the red light in the TM0 mode;
a second light source configured to emit the green light in the TM0 mode; and
a third light source configured to emit the blue light in the TM0 mode.

### [Clause 12]

A retinal projection device mounted on a near-eye wearable device, the retinal projection device comprising:
the laser module according to clause 11;
a movable mirror configured to perform scanning with the laser light emitted from the laser module; and
a reflector configured to project an image onto a retina of a user wearing the near-eye wearable device by reflecting the laser light having passed through the movable mirror and irradiating the retina with reflected light.

### [Clause 13]

A near-eye wearable device comprising:
the retinal projection device according to clause 12; and
a lens provided with the reflector.

What is claimed is:

1. An optical element comprising:
a substrate including a main surface; and
a core layer provided on the main surface and made of a material having an electro-optic effect,
wherein the core layer comprises a mode converter configured to convert a polarization mode of visible light from a TM0 mode to a TE0 mode,
wherein the mode converter comprises:
a first waveguide extending in a first direction along the main surface; and
a second waveguide extending in the first direction,
wherein the first waveguide comprises:
a taper section including a first incident end on which the visible light is incident and a first emission end from which the visible light is emitted, the taper section having a length in a second direction along the main surface and intersecting the first direction that increases from a first length at the first incident end to a second length toward the first emission end; and
a first line section through which the visible light emitted from the first emission end propagates,
wherein the second waveguide comprises a second line section arranged side by side with the first line section in the second direction,
wherein the first length is a length at which a first effective refractive index, which is an effective refractive index of the TM0 mode, is higher than a second effective refractive index, which is an effective refractive index of a TE1 mode,
wherein the second length is a length at which the first effective refractive index is lower than the second effective refractive index,
wherein the first line section and the second line section constitute an asymmetrical directional coupler,
wherein the asymmetrical directional coupler includes a second incident end and a second emission end which are both ends in the first direction, and
wherein a length of the first line section in the second direction and a length of the second line section in the second direction are set such that a magnitude relationship between the second effective refractive index in the first line section and a third effective refractive index, which is an effective refractive index of the TE0 mode, in the second line section at a position different from the second incident end of the asymmetrical directional coupler is inverted to a magnitude relationship between the second effective refractive index in the first line section and the third effective refractive index in the second line section at the second incident end.

2. The optical element according to claim 1,
wherein the length of the first line section in the second direction increases from the second incident end toward the position, and
wherein the length of the second line section in the second direction increases from the second incident end toward the position.

3. The optical element according to claim 1,
wherein the length of the first line section in the second direction increases from the second incident end toward the position, and
wherein the length of the second line section in the second direction is constant over a range from the second incident end to the position.

4. The optical element according to claim 1,
wherein the length of the first line section in the second direction and the length of the second line section in the second direction are set such that a magnitude relationship between the second effective refractive index in the first line section and the third effective refractive index in the second line section at the second emission end is inverted to a magnitude relationship between the second effective refractive index in the first line section and the third effective refractive index in the second line section at the position.

5. The optical element according to claim 1,
wherein the mode converter further comprises a flat plate-shaped slab on which the first waveguide and the second waveguide are provided.

6. The optical element according to claim 5,
wherein a length of the mode converter in a third direction intersecting the first direction and the second direction is smaller than a wavelength of the visible light.

7. The optical element according to claim 1,
wherein a cross-sectional shape of the first waveguide intersecting the first direction is a trapezoidal shape whose length in the second direction increases toward the main surface.

8. The optical element according to claim 1,
wherein the core layer comprises:
a first mode converter which is the mode converter configured to convert a polarization mode of red light from the TM0 mode to the TE0 mode;
a second mode converter which is the mode converter configured to convert a polarization mode of green light from the TM0 mode to the TE0 mode;
a third mode converter which is the mode converter configured to convert a polarization mode of blue light from the TM0 mode to the TE0 mode; and
a multiplexer configured to multiplex the red light, the green light, and the blue light to emit laser light.

9. The optical element according to claim 8,
wherein a length of the first mode converter in a third direction intersecting the first direction and the second direction, a length of the second mode converter in the third direction, and a length of the third mode converter in the third direction are equal to each other.

10. The optical element according to claim 8,
wherein the core layer further comprises:
a first modulator configured to modulate light intensity of the red light;
a second modulator configured to modulate light intensity of the green light; and
a third modulator configured to modulate light intensity of the blue light.

11. A laser module comprising:
the optical element according to claim 8;
a first light source configured to emit the red light in the TM0 mode;
a second light source configured to emit the green light in the TM0 mode; and
a third light source configured to emit the blue light in the TM0 mode.

12. A retinal projection device mounted on a near-eye wearable device, the retinal projection device comprising:
the laser module according to claim 11;
a movable mirror configured to perform scanning with the laser light emitted from the laser module; and
a reflector configured to project an image onto a retina of a user wearing the near-eye wearable device by reflecting the laser light having passed through the movable mirror and irradiating the retina with reflected light.

13. A near-eye wearable device comprising:
the retinal projection device according to claim 12; and
a lens provided with the reflector.
